(19) United States
(12) Patent Application Publication
(10) Pub. No.: US 2010/0073960 A1
(43) Pub. Date: Mar. 25, 2010

(54) Color pattern forming device

(76) Inventor: Yi-Hsueh Yang, Taipei City (TW)

Correspondence Address: Muncy, Geissler, Olds & Lowe, PLLC, P.O. BOX 1364, FAIRFAX, VA, 22038-1364, US

(21) Appl. No.: 12/284,182

(22) Filed: Sep. 22, 2008

(51) Int. Cl. F21V 7/04

(52) U.S. Cl. 362/612

(57) ABSTRACT

A color pattern forming device includes an image displaying module, a base and a set of light-emitting diode (LED) banks. The image displaying module includes three curved light guide plates, each engraved with a pattern block. The set of LED banks includes three LED banks, which project light into corresponding ones of the curved light guide plates. Light from the LED banks is mixed in the curved light guide plates and illuminates each of the pattern blocks, thereby turning the pattern blocks into a color image for display.

### BACKGROUND OF THE INVENTION

1. Technical Field

The present invention relates to a color pattern forming device, and more particularly, to a decorative device capable of forming a color pattern.

2. Description of Related Art

Higher income and better quality of life encourage more material desires. Generally, people like to have various kinds of decorations at home, in offices or in other particular places. Among the wide variety of decorations, some people prefer those carved from acrylic, crystal or glass. Such decorations, though beautiful with their clear and lustrous appearance, only present a transparent, monochromatic and invariable carved configuration. Therefore, a so-called laser carving technology has emerged, allowing stereoscopic characters, numerals or particular patterns to be carved inside an object made of acrylic, crystal, glass or other transparent materials in such a way that various visual effects can be obtained when viewed at different angles. However, characters, numerals or patterns carved by laser only show a single hue without any variation.

Additionally, some manufacturers add dyes of various colors into raw materials of acrylic, crystal or glass to make the acrylic, crystal or glass products colorful. Then laser carving is performed on the products to produce different visual effects in colors. Unfortunately, as the dyes added only present given colors which are invariable, the decorations thus made tend to be boring after they are displayed for a while.

### BRIEF SUMMARY OF THE INVENTION

The primary objective of the present invention is to provide a color pattern forming device comprising an image displaying module, a base and a set of light-emitting diode (LED) banks. The image displaying module includes three curved light guide plates. The set of LED banks comprises three LED banks and is disposed within a groove of the base, wherein the three LED banks can emit a red light, a green light and a blue light, respectively. When disposed in the groove, each of the three curved light guide plates has a bottom thereof corresponding to one of the LED banks. The different color lights emitted from the three LED banks are mixed in pattern blocks engraved respectively on the curved light guide plates, allowing the three pattern blocks to jointly form a color pattern for display.

A secondary objective of the present invention is to provide the aforesaid color pattern forming device, wherein the image displaying module may further be a transparent container, and the base is further provided with a pressure sensor for sensing an overall weight of the transparent container when the transparent container is placed on the base. In response to a different sensed weight of the transparent container that depends on a quantity of liquid contained therein, the pressure sensor drives a first, a second and a third LED bank in such a way that the three LED banks project light simultaneously, singularly or in pair. Consequently, color variation of a pattern block on the transparent container can be achieved depending on the quantity of liquid contained therein, thereby providing a variety of color patterns for display.

### BRIEF DESCRIPTION OF THE SEVERAL VIEWS OF THE DRAWINGS

The invention as well as a preferred mode of use and advantages thereof will be best understood by referring to the following detailed description of illustrative embodiments in conjunction with the accompanying drawings, wherein:

FIG. 1 shows a perspective view of the present invention;

FIG. 2 shows an exploded perspective view of the present invention;

FIG. 3 shows a first view of a preferred embodiment of the present invention;

FIG. 4 shows a second view of the preferred embodiment of the present invention;

FIG. 5 shows a third view of the preferred embodiment of the present invention;

FIG. 6 shows a fourth view of the preferred embodiment of the present invention;

FIG. 7 shows a first view of a second embodiment of the present invention;

FIG. 8 shows a second view of the second embodiment of the present invention;

FIG. 9 shows a third view of the second embodiment of the present invention;

FIG. 10 shows a fourth view of the second embodiment of the present invention;

FIG. 11 shows a third embodiment of the present invention; and

FIG. 12 shows a fourth embodiment of the present invention.

### DETAILED DESCRIPTION OF THE INVENTION

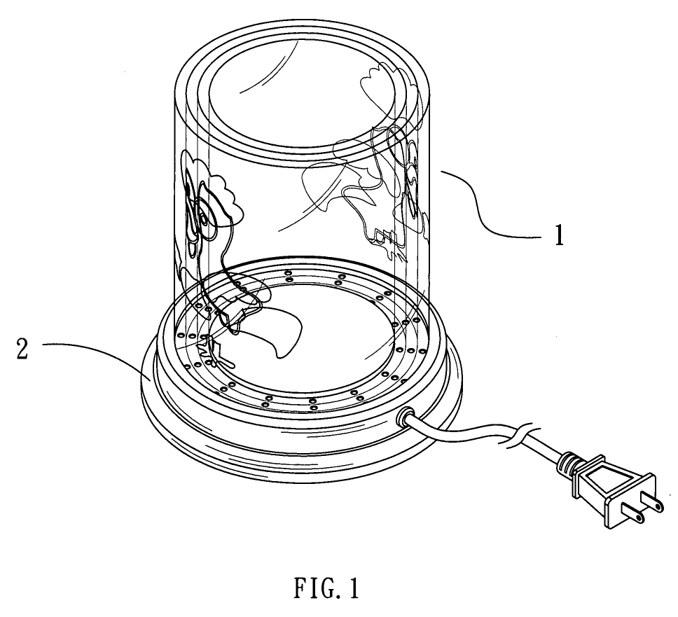

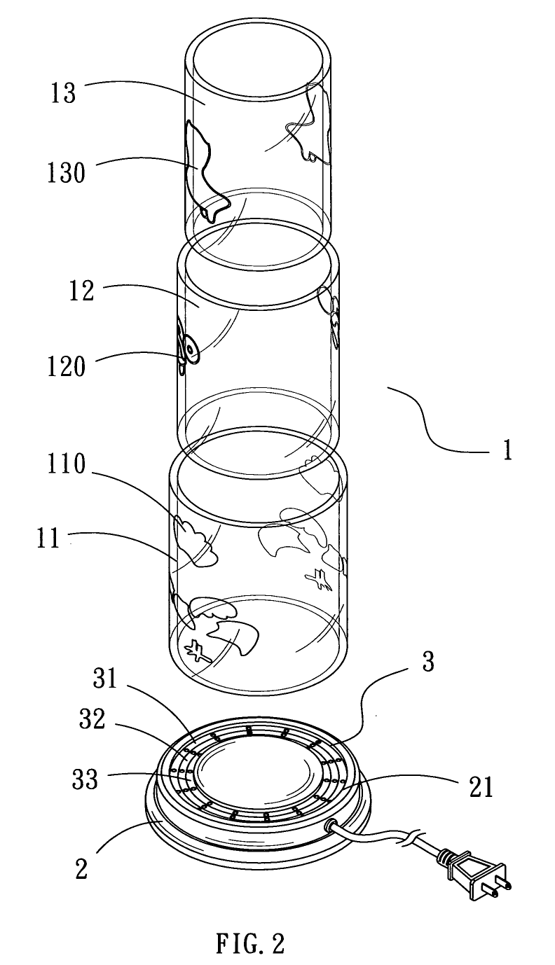

Refer to FIGS. 1 and 2 for a perspective view and an exploded perspective view of a color pattern forming device of the present invention. As can be seen clearly in these drawings, the color pattern forming device comprises an image displaying module 1, a base 2 and a set of LED banks 3.

The image displaying module 1 comprises three curved light guide plates formed of a transparent material, namely, a first curved light guide plate 11, a second curved light guide plate 12 and a third curved light guide plate 13, on which plates a first pattern block 110, a second pattern block 120 and a third pattern block 130 including characters, numerals or particular patterns are engraved, respectively.

The base 2 has a side formed with an annular groove 21 for receiving the image displaying module 1.

The set of LED banks 3 comprises three LED banks, namely, a first LED bank 31, a second LED bank 32 and a third LED bank 33, which three LED banks emit different color lights.

A bottom of the image displaying module 1 is settled in the annular groove 21 of the base 2, so that the first, the second and the third curved light guide plates 11, 12, 13 have their respective bottoms disposed at locations corresponding to the first, the second and the third LED banks 31, 32 and 33, respectively. When the first, the second and the third curved light guide plates 11, 12, 13 are assembled together, the first, the second and the third pattern blocks 110, 120, 130 engraved thereon jointly form a complete pattern.

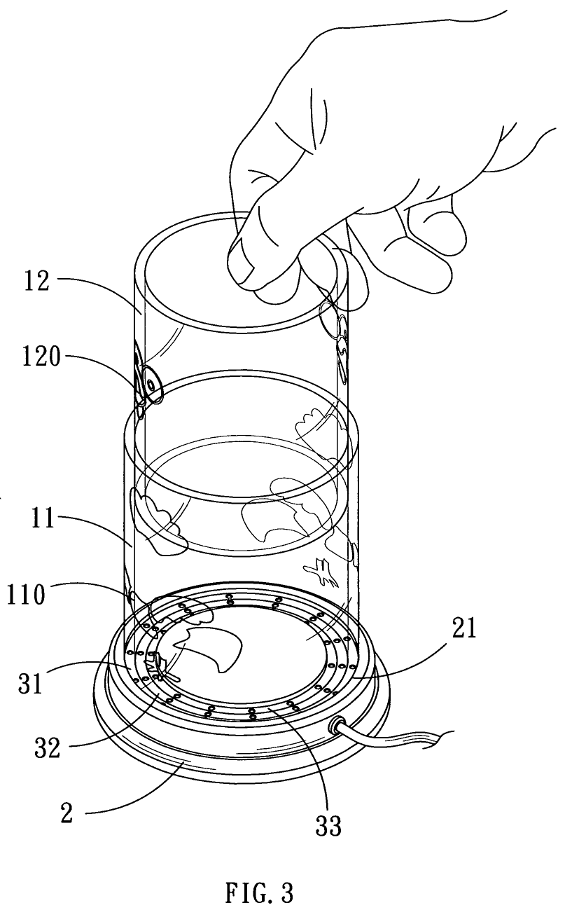

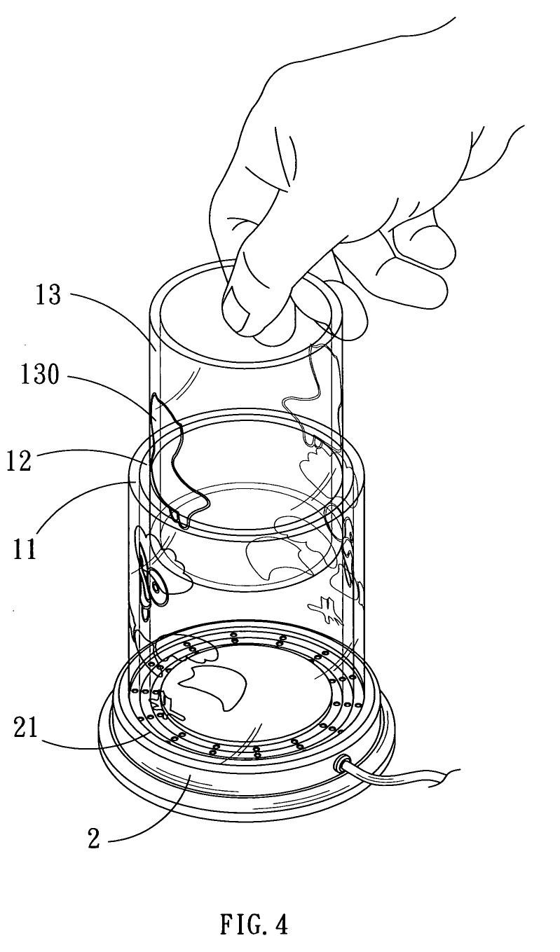

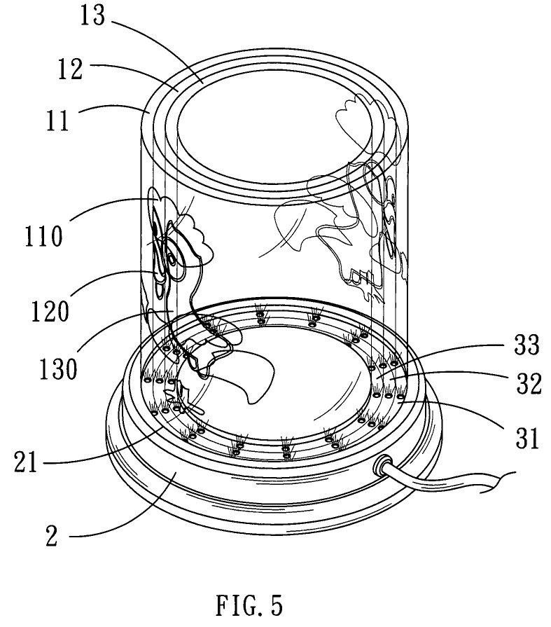

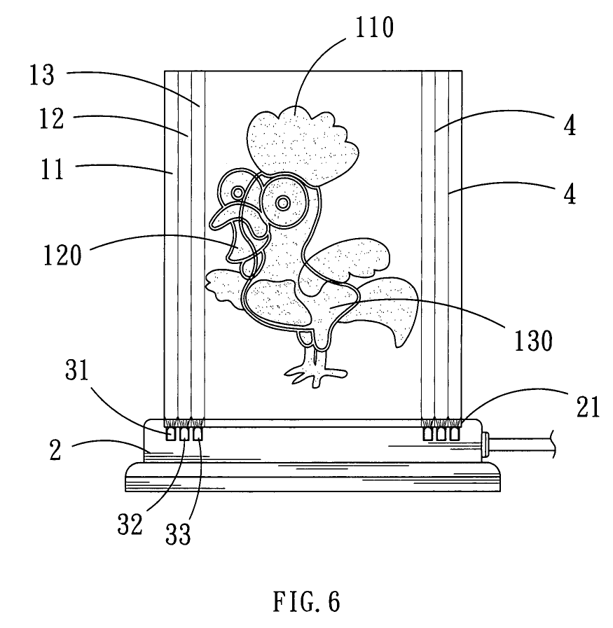

FIGS. 2, 3, 4, 5 and 6 show a preferred embodiment of this invention. As can be seen clearly in these drawings, the first, the second and the third curved light guide plates 11, 12, 13 of the image displaying module 1 are disposed in sequence into the annular groove 21 of the base 2, so that the set of LED banks 3 in the annular groove 21 is positioned under the image displaying module 1, with the first, the second and the third curved light guide plates 11, 12, 13 of the image displaying module 1 corresponding to the first, the second and the third LED banks 31, 32, 33, respectively. When the set of LED banks 3 is driven, each of the LED banks projects a different monochromatic light into the corresponding first, second or third curved light guide plate 11, 12, 13. As a result, the different color lights from the first, the second and the third LED banks 31, 32, 33 are mixed in the first, the second and the third pattern blocks 110, 120, 130 of the first, the second and the third curved light guide plates 11, 12, 13, thereby presenting to viewers a complete colorful pattern consisting of the first, the second and the third pattern blocks 110, 120, 130.

To avoid interference between the curved light guide plates when the set of LED banks 3 projects light thereinto, the curved light guide plates must be individually provided, and when the first, the second and the third curved light guide plates 11, 12, 13 are assembled into the image displaying module 1, a medium layer 4 formed of an adhesive or air must be applied between the first and the second curved light guide plates 11, 12 and between the second and the third curved light guide plates 12, 13 for secure assembly, wherein the medium layer 4 has a density different from those of the three curved light guide plates. It can be known from the Snell's Law that, when light passes through different media, refraction and reflection occur. Hence, when the first, the second and the third LED banks 31, 32, 33 of the set of LED banks 3 project a red light, a green light and a blue light into the first, the second and the third curved light guide plates 11, 12, 13 respectively, differences between the densities of the curved light guide plates and the medium layers 4 interposed therebetween will cause refraction and reflection of the lights propagating in the curved light guide plates, so that the pattern blocks engraved on the curved light guide plates are illuminated to form a complete color pattern.

Furthermore, the first, the second and the third LED banks 31, 32, 33 of the set of LED banks 3 may project light in different combinations. For example, there may be only one LED bank projecting light, or two LED banks projecting light simultaneously or alternately, or three LED banks projecting light in sequence or in a random and intermittent way. Accordingly, when the first, the second and the third curved light guide plates 11, 12, 13 are illuminated by different color lights projected in different ways, visual effects of different depths and colors can be delivered.

Additionally, the image displaying module 1 and the set of LED banks 3 may have only two curved light guide plates and two LED banks, respectively, so as to present a color pattern composed of two pattern blocks which are provided respectively on the two curved light guide plates and are illuminated by a mixture of two different color lights projected from the two LED banks. With the above arrangement, the color pattern forming device of the present invention is distinguished from conventional decorations made of acrylic, crystal or glass by eliminating such shortcomings as monochromatic and invariable visual effects. By stratifying a final pattern into the pattern blocks in the image displaying module 1 and projecting different color lights from the set of LED banks 3, colorful and stereoscopic visual effects can be obtained instead.

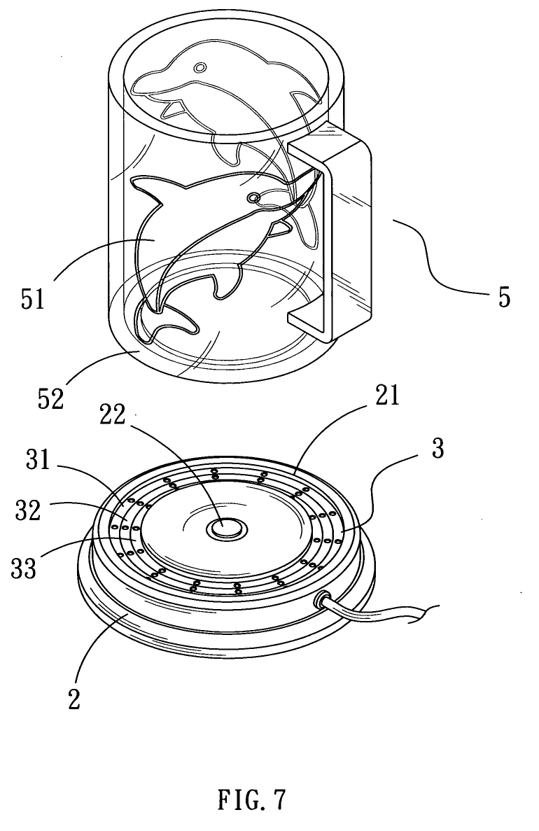

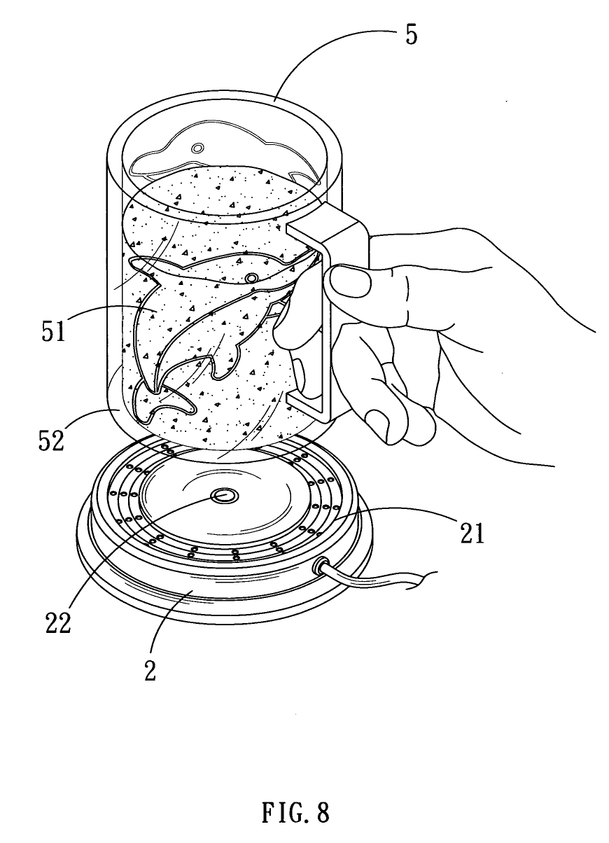

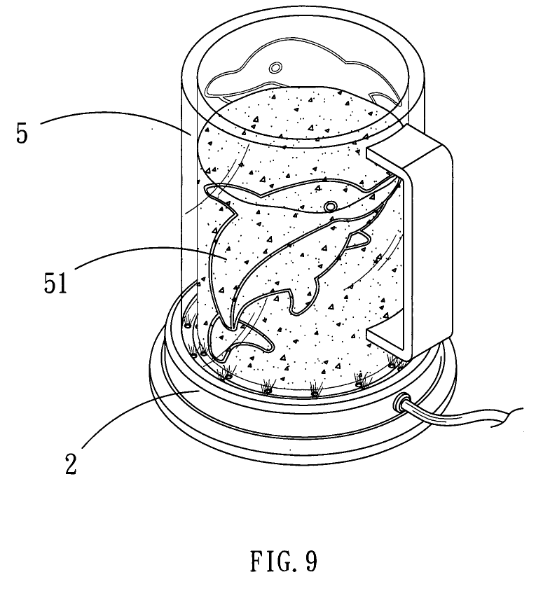

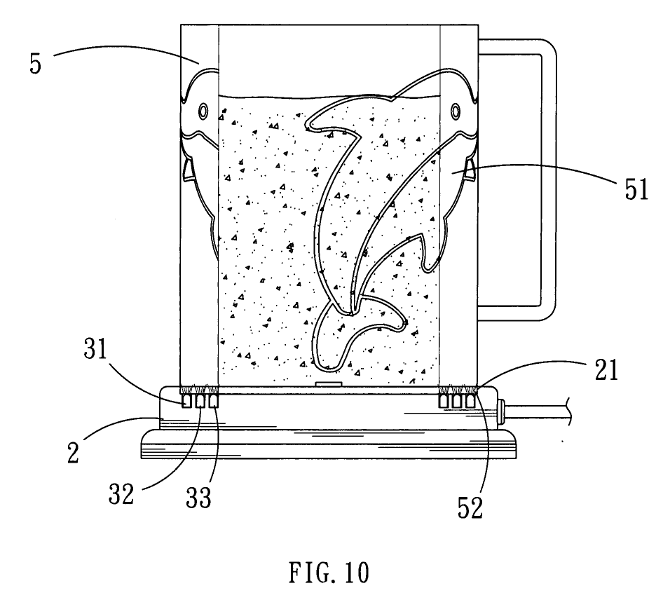

Referring to FIGS. 7, 8, 9 and 10, a color pattern forming device according to a second embodiment of the present invention comprises a transparent container 5, a base 2 and a set of LED banks 3.

The transparent container 5 is engraved with a pattern block 51 including characters, numerals or particular patterns and is provided with an annular rim 52 formed of a transparent material at a bottom of the transparent container 5.

The base 2 is formed with an annular groove 21 and provided with a pressure sensor 22.

The set of LED banks 3 comprises a first, a second and a third LED bank 31, 32, 33 and is disposed within the annular groove 21 of the base 2.

The transparent container 5 is disposed in the annular groove 21 of the base 2 and thereby assembled with the base 2 via the annular rim 52 formed of the transparent material at the bottom of the transparent container 5. When the transparent container 5 is disposed on the base 2, the bottom of the transparent container 5 also makes contact with the pressure sensor 22 of the base 2. Upon sensing a weight of the transparent container 5, the pressure sensor 22 drives the set of LED banks 3 in the annular groove 21 to project light into the transparent container 5 so that light from the set of LED banks 3 is mixed in and illuminates the pattern blocks 51 engraved on the transparent container 5, thereby presenting the pattern blocks 51 in colors. As the transparent container 5 may contain different quantities of liquid, the set of LED banks 3 can, in response to a different overall weight of the transparent container 5 sensed by the pressure sensor 22, drive the first, the second and the third LED banks 31, 32, 33 in such a way that the three LED banks project light simultaneously, singularly or in pair. Therefore, when the transparent container 5 is placed on the base 2, different light projection effects can be delivered to the transparent container 5 by the first, the second and the third LED banks 31, 32, 33 depending on the quantity of liquid contained in the transparent container 5, so as to provide color variations in the pattern blocks 51 on the transparent container 5.

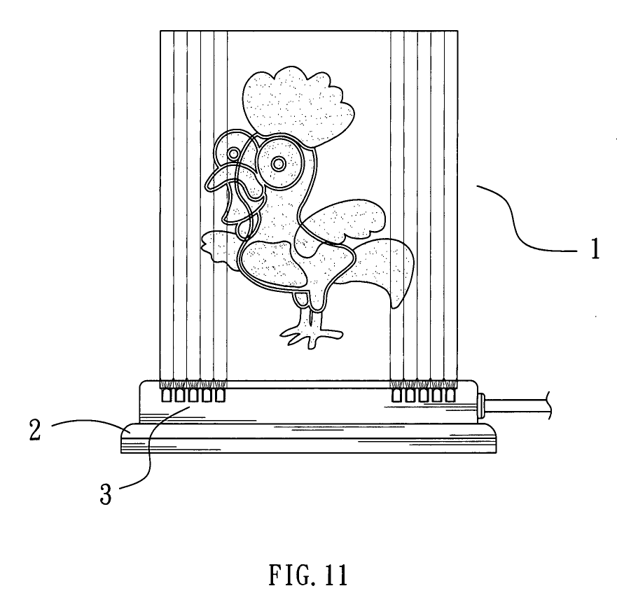

FIG. 11 shows a third embodiment of the present invention. As can be seen clearly in this drawing, the image displaying module 1 comprises five curved light guide plates and the number of LED banks in the set of LED banks 3 disposed on the base 2 is also increased to five accordingly, wherein each of the LED banks emits a light of a different single color. Thus, by illuminating more curved light guide plates with the set of LED banks 3 having more LED banks, visual effects of more saturated colors and more distinctive layers can be obtained.

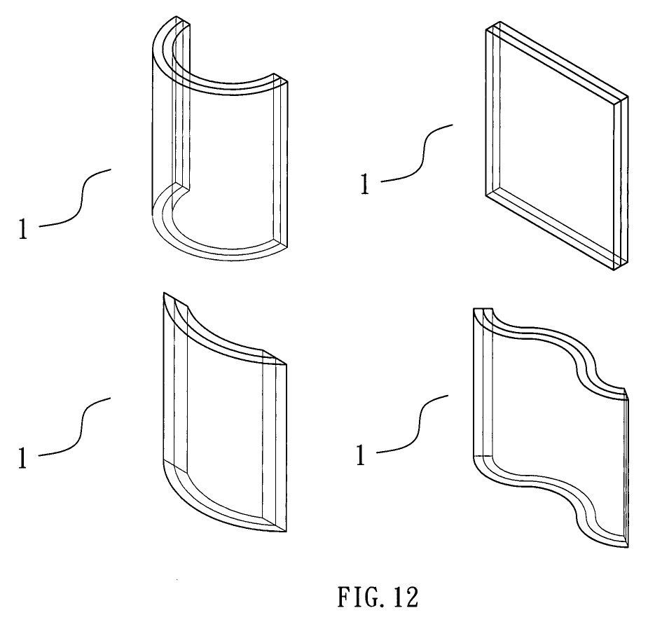

FIG. 12 shows a fourth embodiment of the present invention. As can be seen clearly in this drawing, the curved light guide plates of the image displaying module 1 may have a planar, arcuate, semi-curved or wavy configuration, so that various visual effects can be produced with light guide plates of these different configurations when light is projected thereinto.

1. A color pattern forming device, comprising:
at least one image displaying module, comprising two or more curved light guide plates, wherein each said curved light guide plate is engraved with a pattern block, and when the curved light guide plates are stacked together, the pattern blocks engraved on the curved light guide plates jointly form a pattern;
a base, formed with an annular groove for receiving the image displaying module; and
a set of LED banks, comprising at least two LED banks disposed in the annular groove of the base;
wherein when the curved light guide plates of the image displaying module are disposed in the annular groove of the base, each said LED bank in the annular groove projects light towards a corresponding one of the curved light guide plates, so that the light from the different LED banks is mixed in the pattern blocks on the curved light guide plates, thereby presenting the pattern jointly formed by the pattern blocks in colors.

2. The color pattern forming device of claim 1, wherein the image displaying module comprises at least one said curved light guide plate.

3. The color pattern forming device of claim 2, wherein the curved light guide plates have a planar, arcuate, semi-curved or wavy configuration.

4. The color pattern forming device of claim 1, wherein the curved light guide plates are made of a transparent material.

5. The color pattern forming device of claim 1, wherein the pattern blocks engraved on the curved light guide plates include characters, numerals or particular patterns.

6. The color pattern forming device of claim 1, wherein each two adjacent said curved light guide plates are assembled together securely by a medium layer interposed therebetween.

7. The color pattern forming device of claim 6, wherein the medium layer is an adhesive or air.

8. The color pattern forming device of claim 1, wherein each said LED bank of the set of LED banks projects light of a different color.

9. A color pattern forming device, comprising:
a transparent container, engraved with a pattern block and formed with an annular rim at a bottom of the transparent container;
a base, formed with an annular groove; and
a set of LED banks, comprising at least two LED banks and disposed in the annular groove of the base;
wherein when the transparent container is placed on the base, the annular rim at the bottom of the transparent container is disposed in the annular groove of the base so that the transparent container is assembled with the base stably, allowing the set of LED banks in the annular groove to project light towards the transparent container, in which the projected light is mixed in the pattern block on the transparent container so as to present the pattern block in colors.

10. The color pattern forming device of claim 9, wherein the annular rim at the bottom of the transparent container is made of a transparent material.

11. The color pattern forming device of claim 9, wherein the pattern block engraved on the transparent container includes characters, numerals or particular patterns.

12. The color pattern forming device of claim 9, wherein the LED banks project light of at least one of red, green and blue colors.

13. The color pattern forming device of claim 9, wherein the base is further provided with a pressure sensor for sensing an overall weight of the transparent container when the transparent container is placed on the base, so that luminance of the set of LED banks varies with the weight of the transparent container that depends on a quantity of liquid contained therein.
